(19) United States
(12) Patent Application Publication
(10) Pub. No.: US 2017/0261265 A1
(43) Pub. Date: Sep. 14, 2017

(54) APPARATUS AND METHOD FOR MANUFACTURING COPPER ALLOY MATERIAL

(71) Applicant: HITACHI METALS, LTD., Tokyo (JP)

(72) Inventors: Keisuke FUJITO, Tokyo (JP); Shohei Hata, Tokyo (JP); Takayuki Tsuji, Tokyo (JP); Hiromitsu Kuroda, Tokyo (JP)

(21) Appl. No.: 15/447,261

(22) Filed: Mar. 2, 2017

(30) Foreign Application Priority Data
Mar. 10, 2016 (JP) 2016-047194

(51) Int. Cl. F27D 25/00; C22C 1/02; F27D 21/00; F27D 3/14; F27D 19/00

(52) U.S. Cl. CPC F27D 25/00; F27D 3/14; F27D 19/00; F27D 21/00; C22C 1/02

(57) ABSTRACT

There is provide an apparatus for manufacturing a copper alloy metal material, including: a tundish in which molten copper is stored; a pouring nozzle through which the molten copper passes, the molten copper being flowed out from the tundish; a pressure variation device that varies a pressure applied to the pouring nozzle by the molten copper; and a controller that controls the pressure variation device so as to remove inclusions adhered to the pouring nozzle, by increasing the pressure applied to the pouring nozzle by the molten copper.

The present application is based on Japanese Patent Application No. 2016-047194 filed on Mar. 10, 2016, the entire contents of which are hereby incorporated by reference.

### BACKGROUND

Technical Field

The present invention relates to an apparatus and a method for manufacturing a copper alloy material.

Description of Related Art

As a method for manufacturing copper and copper alloy wire rods, a continuous casting and rolling apparatus is used for manufacturing a long product without loss. When an element is added to a molten copper to produce a copper alloy material by a continuous casting rolling method, an oxide of an alloy component is produced in some cases in the molten copper depending on the element to be added (see patent document 1 for example, for manufacture of the copper alloy material). Further, due to continuous casting, a refractory constituting a furnace or a foreign matter mixed in the material, is sometimes mixed as it is in the product.

Patent document 1: Patent Publication No. 4709296

### SUMMARY OF THE INVENTION

In the continuous casting, inclusions such as an oxide of an alloy component contained in molten copper, or a refractory constituting a furnace, or a foreign matter mixed in a material, or the like, are adhered to a pouring nozzle provided at the exit of a tundish in the casting, and the pouring nozzle sometimes becomes clogged.

An object of the present invention is to provide a technique of cleaning the inclusions adhered to the pouring nozzle when manufacturing a copper alloy material.

According to an aspect of the present invention, there is provided an apparatus for manufacturing a copper alloy material, including:

a tundish in which molten copper is stored;

a pouring nozzle through which the molten copper passes, the molten copper being flowed out from the tundish;

a pressure variation device that varies a pressure applied to the pouring nozzle by the molten copper; and

a controller that controls the pressure variation device so as to remove inclusions adhered to the pouring nozzle, by increasing the pressure applied to the pouring nozzle by the molten copper.

According to another aspect of the present invention, there is provided a method for manufacturing a copper alloy material, including:

storing a molten copper in a tundish;

making the molten copper flow out from the tundish through a pouring nozzle;

removing inclusions adhered to the pouring nozzle which is caused during flow out of the molten copper through the pouring nozzle, by increasing a pressure applied to the pouring nozzle by the molten copper.

The inclusions adhered to the pouring nozzle can be cleaned.

### BRIEF DESCRIPTION OF THE DRAWINGS

FIG. 1 is a schematic configuration view of a continuous casting and rolling apparatus (configurations are common in first to third embodiments) according to an embodiment of the present invention.

FIG. 2A and FIG. 2B are schematic configuration views showing the expanded vicinity of a tundish, a pressure variation device, a controller, and a detector (configurations are common in first to third embodiments) of a continuous casting and rolling apparatus according to an embodiment.

FIG. 3A and FIG. 3B are schematic configuration views showing the expanded vicinity of a tundish, a pressure variation device, a controller, and a detector of the continuous casting and rolling apparatus according to a first embodiment.

FIG. 4A and FIG. 4B are schematic configuration views showing the expanded vicinity of a tundish, a pressure variation device, a controller, and a detector of the continuous casting and rolling apparatus according to a modified example of the first embodiment.

FIG. 5A and FIG. 5B are schematic configuration views showing the expanded vicinity of a tundish, a pressure variation device, a controller, and a detector of the continuous casting and rolling apparatus according to a second embodiment.

FIG. 6A and FIG. 6B are schematic configuration views showing the expanded vicinity of a tundish, a pressure variation device, a controller, and a detector of the continuous casting and rolling apparatus according to a modified example of the second embodiment.

FIG. 7A and FIG. 7B are schematic configuration views showing the expanded vicinity of a tundish, a pressure variation device, a controller, and a detector of the continuous casting and rolling apparatus according to a third embodiment.

### DETAILED DESCRIPTION OF THE INVENTION

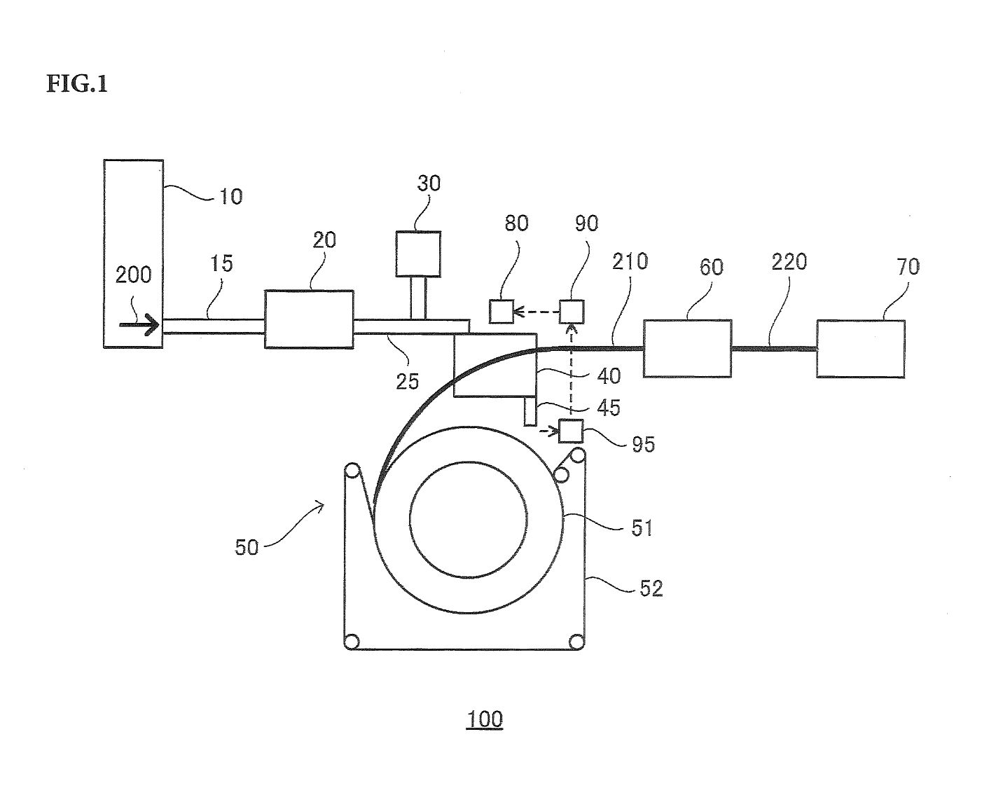

An entire configuration of the apparatus for manufacturing a copper alloy material according to an embodiment of the present invention, will be described hereafter with reference to FIG. 1. In addition, an overall flow of the method for manufacturing a copper alloy material using the above apparatus, will be described. As an example of the apparatus for manufacturing a copper alloy material according to an embodiment, a continuous casting and rolling apparatus will be described. FIG. 1 is a schematic configuration view of a continuous casting and rolling apparatus 100 according to an embodiment. Here, explanation is common in first to third embodiments described later.

The continuous casting and rolling apparatus 100 includes a melting furnace 10, a transfer gutter (upper gutter) 15, a holding furnace 20, a transfer gutter (lower gutter) 25, an alloy component adding part 30, a tundish 40, a pouring nozzle 45, a casting machine 50, A rolling mill 60, a winder 70, a pressure variation device 80, a controller 90, and a detector 95.

The melting furnace 10 is provided for heating and melting a copper raw material to produce molten copper 200, and includes a furnace body and a burner provided in a lower portion of the furnace body. In the melting furnace 10, the copper raw material (for example, electric copper, etc.) injected into the furnace body, is heated and melted by the burner, and the molten copper 200 is continuously produced.

The upper gutter 15 connects the melting furnace 10 and the holding furnace 20. The molten copper 200 produced by the melting furnace 10 is transferred to a downstream side holding furnace 20 via the upper gutter 15.

The holding furnace 20 stores the molten copper 200 transferred from the upper gutter 15 at a prescribed temperature. A certain amount of molten copper 200 is fed to the lower gutter 25 by the holding furnace 20.

The lower gutter 25 connects the holding furnace 20 and the tundish 40. The molten copper 200 is transferred to a downstream side tundish 40 from the holding furnace 20 via the lower gutter 25.

The alloy component adding part 30 is connected to the lower gutter 25. Owing to the alloy component adding part 30, an alloy component is added to the molten copper 200. Examples of the alloy component added to the molten copper 200 include metal elements such as tin (Sn), titanium (Ti), magnesium (Mg), aluminum (Al), calcium (Ca), and manganese (Mn), etc. The method of adding the alloy component is not particularly limited, but for example wire injection can be used, whereby a wire made of an alloy component is injected into the molten copper 200.

The tundish 40 is a storage tank provided to continuously supply the molten copper 200 to the casting machine 50. The molten copper 200 to which the alloy component has been added by the alloy component adding part 30, passes through the lower gutter 25 and is stored in the tundish 40.

A pouring nozzle 45 is provided at the outlet of the tundish 40, through which the molten copper 200 passes, the molten copper 200 being flowed out from the tundish 40. The pouring nozzle 45 is made of a refractory material such as silicon oxide, silicon carbide, silicon nitride, or the like. The molten copper 200 stored in the tundish 40, is supplied to the casting machine 50 through the pouring nozzle 45.

As the casting machine 50, for example a belt wheel type casting machine is used. The belt wheel type casting machine 50 includes a wheel 51 having a groove formed on the outer circumferential surface thereof and a belt 52 rotatably moved so as to be in contact with a part of the outer circumferential surface of the wheel 51. The molten copper 200 is injected into a space formed between the groove of the wheel 51 and the belt 52, through the pouring nozzle 45. The wheel 51 and the belt 52 are cooled by cold water for example, whereby the molten copper 200 is cooled and solidified, and a rod-shaped cast material 210 is continuously cast. As the casting machine 50, a casting machine other than the belt wheel type casting machine, for example, a twin belt type casting machine, etc., may be used.

The rolling mill 60 is provided on the downstream side of the casting machine 50. The rod-like cast material 210 fed from the casting machine 50 is continuously rolled by the rolling mill 60, and is formed into a copper alloy wire 220 having a predetermined outer diameter. The copper alloy wire 220 is wound up by the winder 70 provided on the downstream of the rolling mill 60.

It is found by the inventors of the present invention, that inclusions such as an oxide of an alloy component added to the molten copper 200 or a refractory used for a furnace material, are adhered to or deposited on the vicinity of an opening of the pouring nozzle 45 or an inner face thereof, thereby involving a trouble of a reduction of a flow rate of the molten copper 200 flowed out from the pouring nozzle 45, or clogging of the pouring nozzle 45 in some cases.

In order to suppress such a trouble, it is found that the following cleaning is effective: the inclusions adhered to the pouring nozzle 45 is removed (flowed away) by increasing a pressure applied to the pouring nozzle 45 by the molten copper 200, that is, by increasing a momentum of the molten copper 200 flowed out from the pouring nozzle 45. Such an action of removing the inclusions adhered to the pouring nozzle 45 is sometimes referred to as simply cleaning hereafter.

Here, “the pressure applied to the pouring nozzle 45 by the molten copper 200” means the pressure applied to the pouring nozzle 45 by the mass of the molten copper 200 in the tundish 40, and the pressure applied to the pouring nozzle 45 through the molten copper 200 in the tundish 40.

The continuous casting and rolling apparatus 100 of this embodiment includes a pressure variation device 80, a controller 90, and a detector 95, to perform cleaning. The pressure variation device 80 varies the pressure applied to the pouring nozzle 45 by the molten copper 200. The controller 90 controls the pressure variation device 80 so as to increase the pressure applied to the pouring nozzle 45 by the molten copper 200. That is, the controller 90 controls the pressure variation device 80 so as to remove the inclusions adhered to the pouring nozzle 45 by increasing the pressure applied to the pouring nozzle 45 by the molten copper 200.

The detector 95 is that detects an adhesion of the inclusions to the pouring nozzle 45. When the inclusions adhered to the pouring nozzle 45 are judged to be a prescribed amount or more by using the detector 95, cleaning may be performed.

For example, cleaning may be performed at prescribed time intervals, and in this case, namely, when use of the detector 95 is not required for judging the timing of performing cleaning, the detector 95 may be omitted.

Operation of the continuous casting and rolling apparatus 100 including cleaning is performed as follows, for example. Usually, the operation of manufacturing the product is performed. The operation for manufacturing the product may hereinafter be referred to as a normal operation.

The operation for performing cleaning is executed at a timing when it is judged that a prescribed amount or more of inclusions are adhered to the pouring nozzle 45, or at a timing when the normal operation is performed for a prescribed time. It is preferable that casting and rolling are not interrupted at the time of cleaning. Accordingly, the inclusions flowed away by cleaning are mixed into a cast matter and a rolled matter. Therefore, the cast matter and the rolled matter into which the inclusions flowed away by cleaning are mixed, are preferably excluded from the product.

When the cleaning is completed, the normal operation is performed again. In this manner, the cleaning is performed between normal operations.

The abovementioned cleaning is performed to manufacture an excellent copper alloy material, which is therefore considered to be a part of the method for manufacturing a copper alloy material. The method for manufacturing a copper alloy material including cleaning, includes: storing the molten copper 200 in the tundish 40; flowing out the molten copper 200 from the tundish 40 through the pouring nozzle 45; and performing cleaning of removing the inclusions adhered to the pouring nozzle 45 which is caused when flowing out the molten copper 200 through the pouring nozzle 45, by increasing the pressure applied to the pouring nozzle 45 by the molten copper 200.

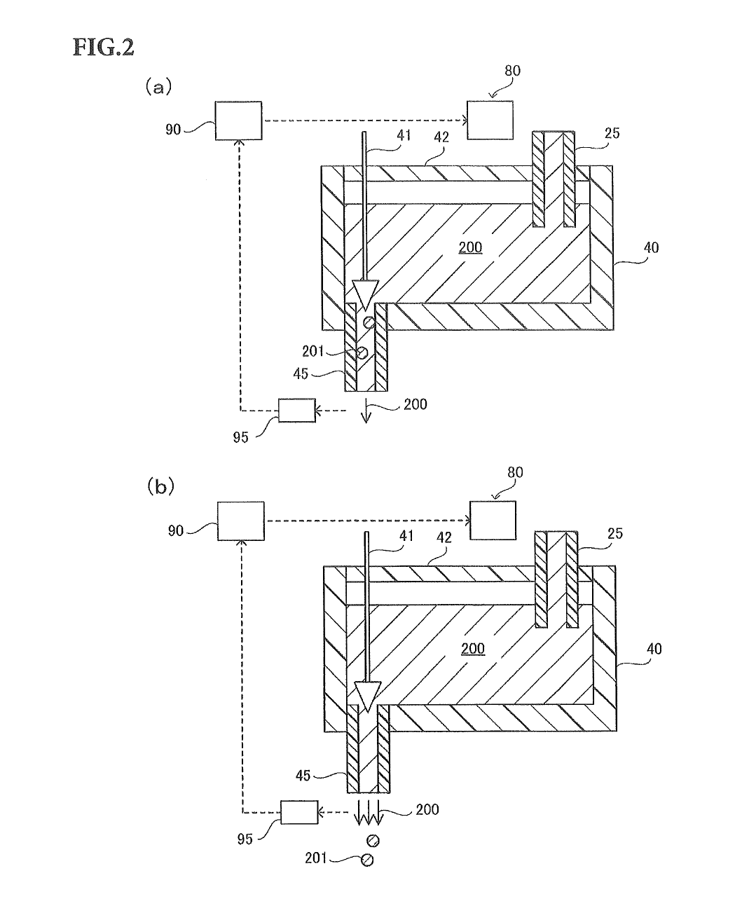

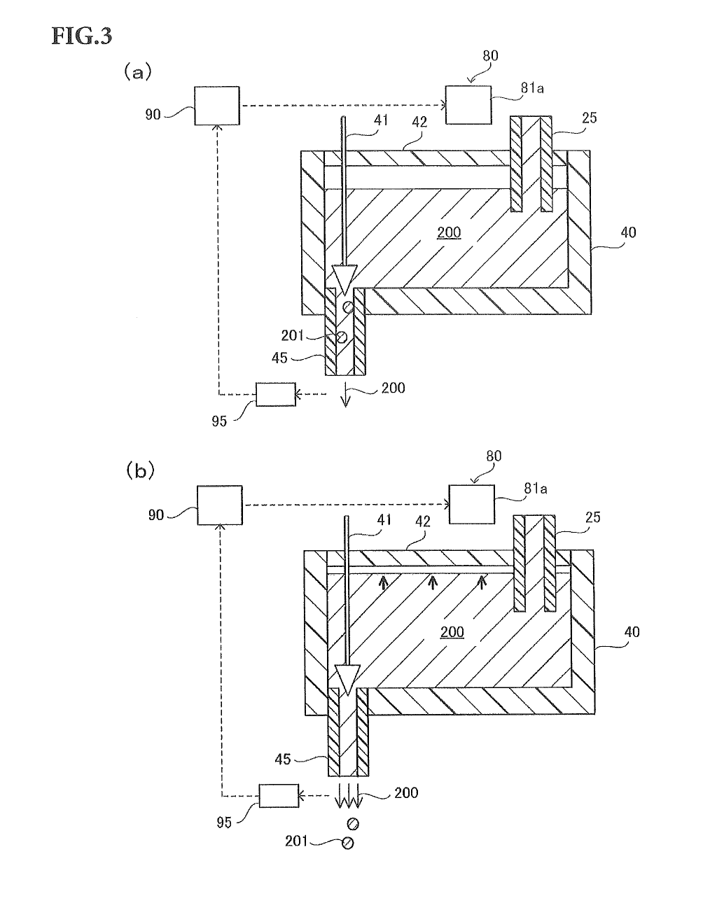

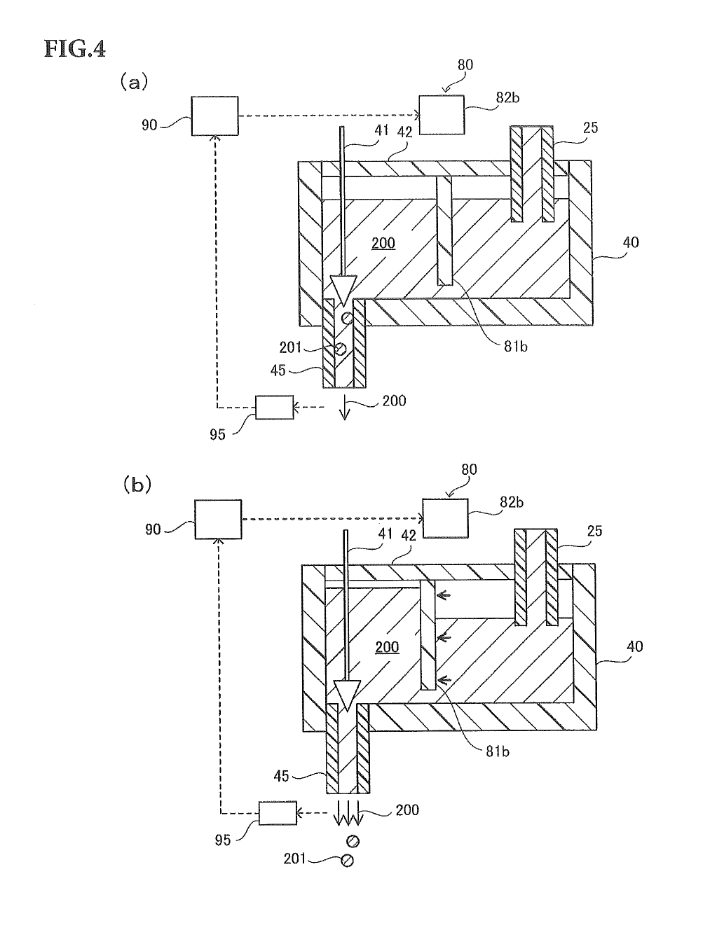

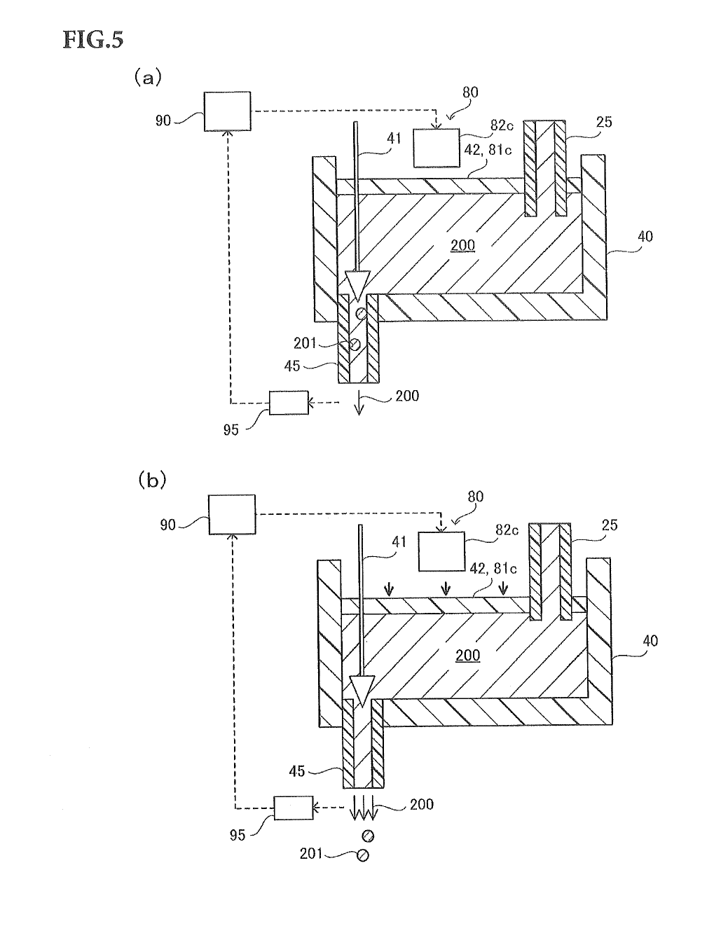

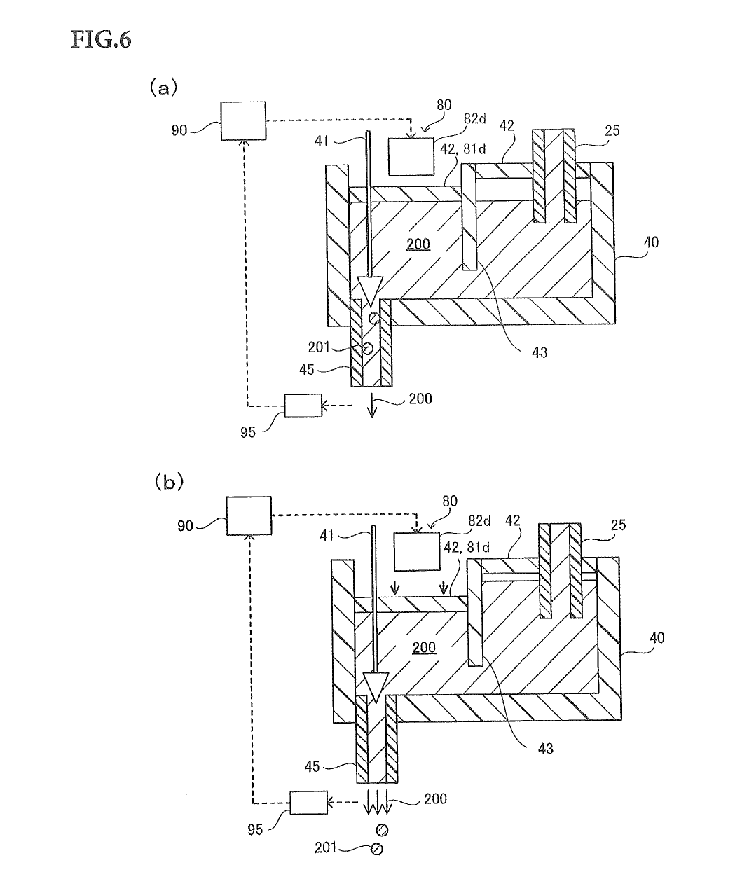

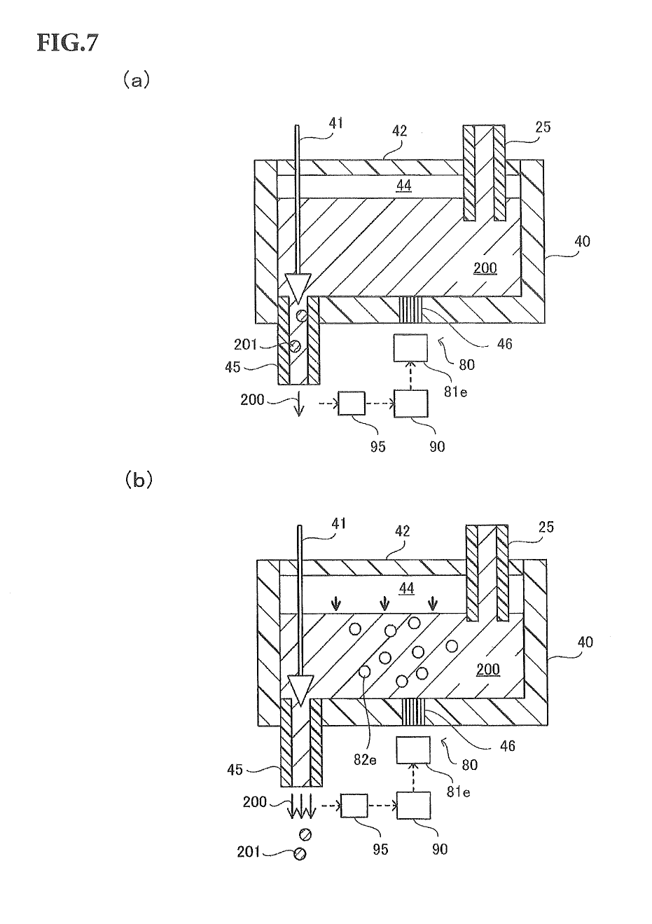

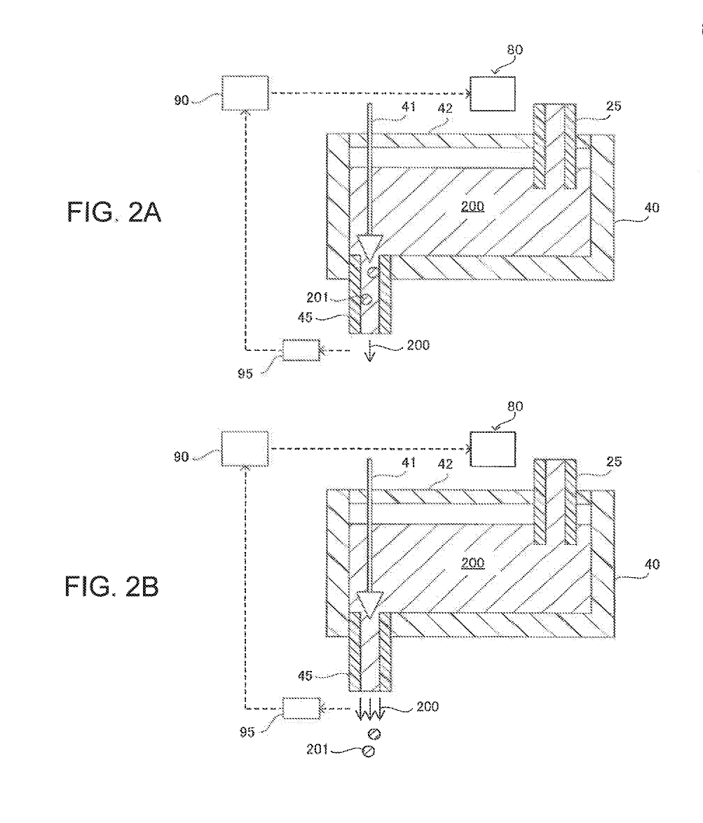

Next, explanation is given for a configuration of the vicinity of the tundish 40, and also for configurations of the pressure variation device 80, the controller 90, and the detector 95 of the continuous casting and rolling apparatus 100 of this embodiment, with reference to FIG. 2A and FIG. 2B. FIG. 2A and FIG. 2B are schematic configuration views showing the expanded vicinity of the tundish 40, the pressure variation device 80, the controller 90, and the detector 95 of the continuous casting and rolling apparatus 100 according to this embodiment. Here, the explanation is common in first to third embodiments described later.

FIG. 2A shows a state in which inclusions 201 are adhered to the pouring nozzle 45 at the time of the normal operation. The molten copper 200 flowed through the lower gutter 25 is stored in the tundish 40. An upper part of the tundish 40 is closed by a lid member 42. The pouring nozzle 45 is disposed at a bottom part on one end side of the tundish 40. A flow rate adjusting pin 41 is provided in the vicinity of an upper side opening of the pouring nozzle 45, for adjusting a substantial size of the upper side opening of the pouring nozzle 45.

At the time of the normal operation, the flow rate of the molten copper 200 flowed into the pouring nozzle 45, is controlled to be constant. When the inclusion 201 is adhered to the pouring nozzle 45, thus narrowing an inner diameter of the pouring nozzle 45, the tip of the flow rate adjusting pin 41 on an upper side of the pouring nozzle 45 is moved away from the pouring nozzle 45, to thereby widen the opening of the pouring nozzle 45, and maintain the flow rate of the molten copper 200 in the pouring nozzle 45.

The detector 95 detects thinning of the inner diameter of the pouring nozzle 45, which shows that the inclusions 201 are adhered to the pouring nozzle 45, by measuring the flow rate of the molten copper 200 flowed out from the pouring nozzle 45. As the detector 95, for example, a camera for observing the flow of the molten copper 200 flowing out from the pouring nozzle 45 can be used. Any type of detector 95 may be used as long as it can detect an adhesion degree of the inclusions 201 to the pouring nozzle 45. A detector that can directly detect an adhesion amount of the inclusions 201, may be used.

A signal transmitted from the detector 95 is inputted in the controller 90. When the amount of the inclusion 201 adhered to the pouring nozzle 45 is judged to be a prescribed amount or more to be cleaned, based on the signal inputted from the detector 95, the controller 90 controls the pressure variation device 80 so as to perform cleaning, namely, so as to increase the pressure applied to the pouring nozzle 45 by the molten copper 200.

As described above, the detector 95 may be omitted, and the controller 90 may control the pressure variation device 80 so as to perform cleaning every time the normal operation is performed for a prescribed time.

FIG. 2B shows a state at the time of cleaning. At the time of cleaning, the pressure applied to the pouring nozzle 45 by the molten copper 200 is increased, so that the momentum of the molten copper 200 flowed out from the pouring nozzle 45 is increased to the extent that the inclusions 201 adhered to the nozzle 45 are flowed away (removed), under control of the controller 90.

At the time of the normal operation of manufacturing the product, it is preferable that the flow state of the molten copper 200 flowing out from the pouring nozzle 45 is kept constant. Therefore, a technique of intentionally varying the pressure applied to the pouring nozzle 45 by the molten copper 200 has not been used so far. The inventors of the present invention propose to perform cleaning as described above by newly using a technique of intentionally varying the pressure applied to the pouring nozzle 45 by the molten copper 200.

Next, explanation is given for a first embodiment and a modified example thereof, a second embodiment and a modified example thereof, and a third embodiment. In each of the embodiments and modified examples, a basic configuration of the continuous casting and rolling apparatus 100 (the melting furnace 10 to the winder 70) and the configurations of the controller 90 and the detector 95 are similar to those described above, and mainly the configuration of the pressure variation device 80 is different depending on each embodiment and each modified example.

In the explanation for each of the embodiments and the modified examples, the same reference numerals are used for mutually corresponding members and structures to avoid complication. In order to make the difference between each embodiment and each modification easy to understand, reference numbers “a” to “e” are added to a detailed configuration of the pressure variation device 80 of the first embodiment and the modified example thereof, the second embodiment and the modified example thereof, and the third embodiment, for showing the difference between them.

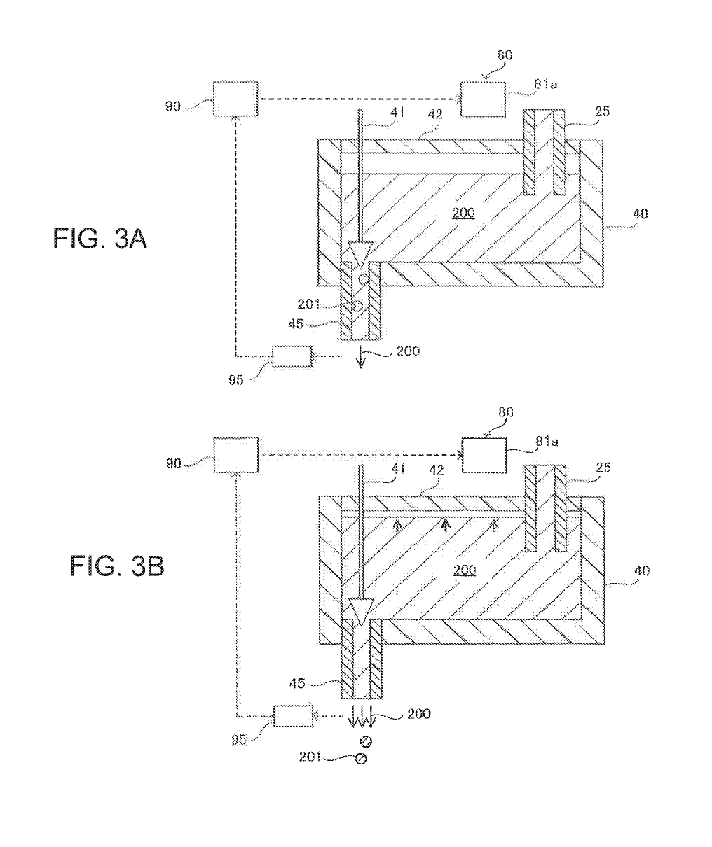

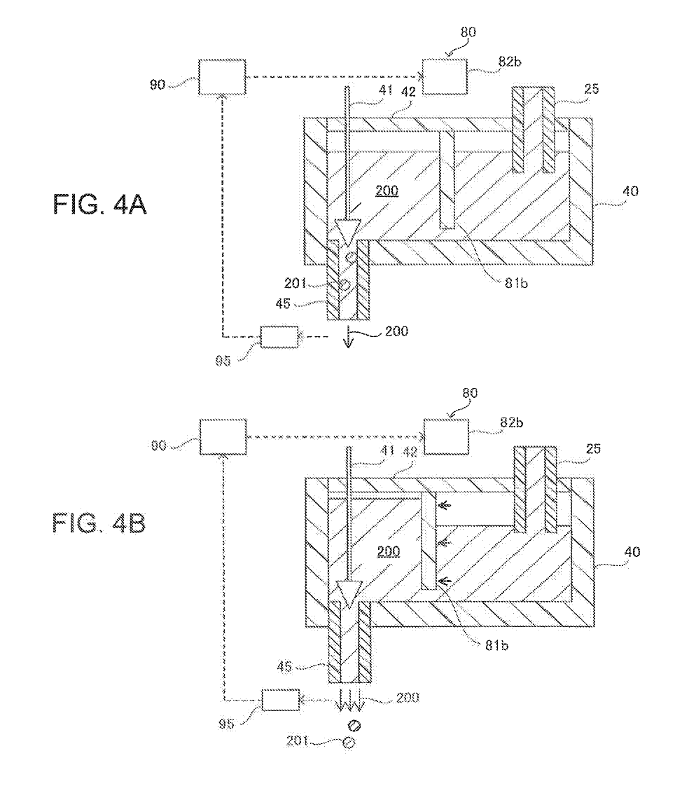

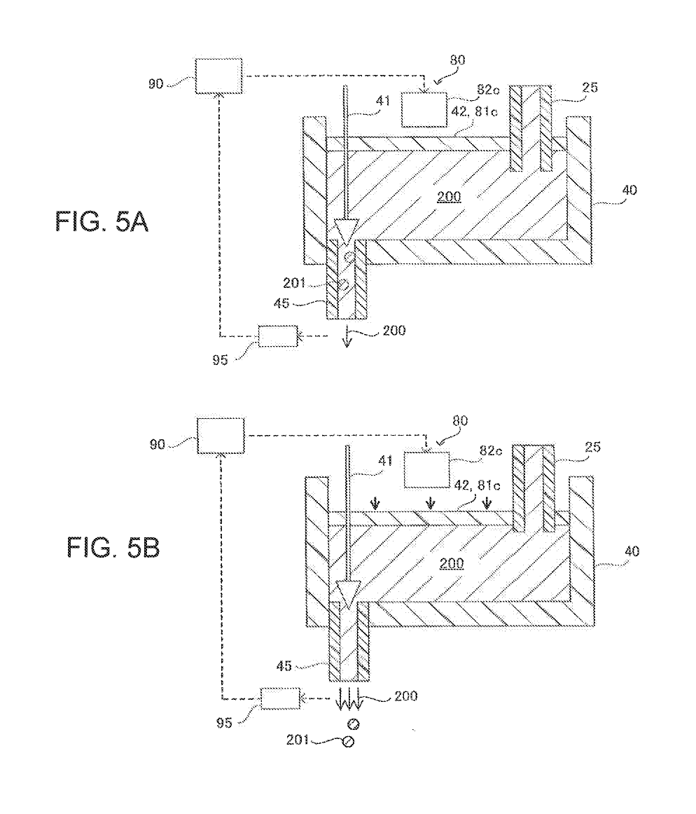

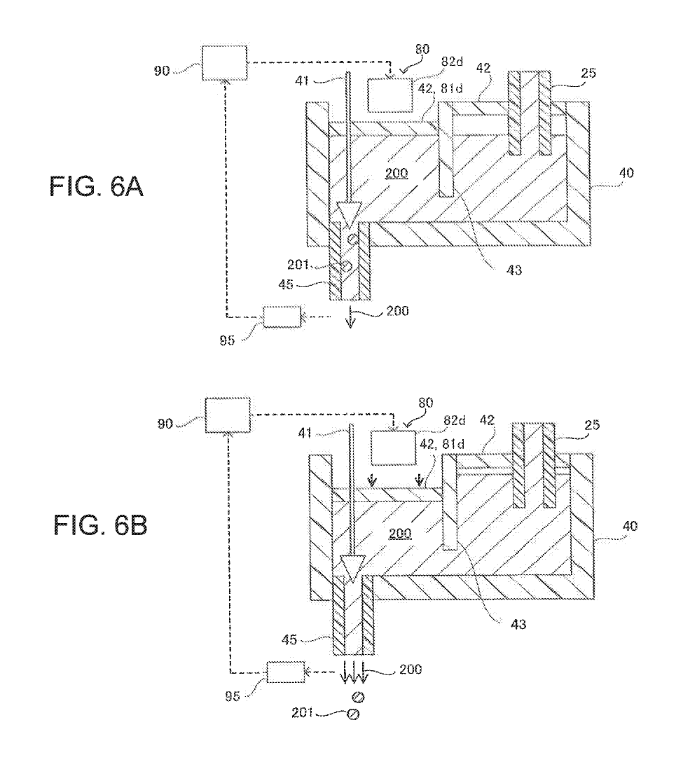

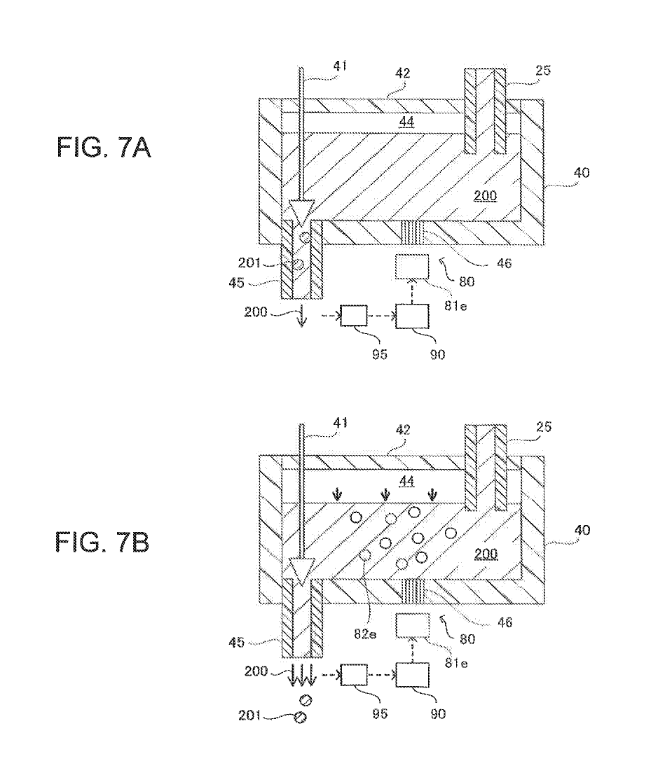

FIG. 3A and FIG. 3B, FIG. 4A and FIG. 4B. FIG. 5A and FIG. 5B, FIG. 6A and FIG. 6B, and FIG. 7A and FIG. 7B are respectively schematic configuration views showing the expanded vicinity of the tundish 40, the pressure variation device 80, the controller 90, and the detector 95 of the continuous casting and rolling apparatus 100 according to the first embodiment and the modified example thereof, the second embodiment and the modified example thereof, and the third embodiment.

FIG. 3A, FIG. 4A, FIG. 5A, FIG. 6A, and FIG. 7A respectively show the state in which the inclusion 201 is adhered to the pouring nozzle 45 at the time of the normal operation. FIG. 3B, FIG. 4B, FIG. 5B, FIG. 6B, and FIG. 7B respectively show the state at the time of cleaning.

As described later in detail, in the first embodiment and the modified example thereof, a pressure variation device that varies the pressure applied to the pouring nozzle 45 by the molten copper 200, by varying a height of a surface of the molten copper 200 in the upper part of the pouring nozzle 45, is used as the pressure variation device 80. Further, in the second embodiment and the modified example thereof, and the third embodiment, a pressure variation device that varies the pressure applied to the pouring nozzle 45 by the molten copper 200 by varying the pressure applied from above to the surface of the molten copper 200 in the upper part of the pouring nozzle 45, is used as the pressure variation device 80.

First, the first embodiment will be described, with reference to FIG. 3A and FIG. 3B. A pressure variation device having a flow rate adjusting device 81a for adjusting the flow rate of the molten copper 200 flowing into the tundish 40 from the lower gutter 25, is used as the pressure variation device 80 of the first embodiment.

At the time of the cleaning, the flow rate adjuster 81a of the pressure variation device 80 increases the flow rate of the molten copper 200 flowed into the tundish 40, thus raising the surface of the molten copper 200 and increasing the pressure applied to the pouring nozzle 45 by the molten copper 200, under control of the controller 90. In the first embodiment, the cleaning is performed in this manner.

The modified example of the first embodiment will be described, with reference to FIG. 4A and FIG. 4B. A pressure variation device including a movable partition member 81b that divides the interior of the tundish 40 in a horizontal direction and set in a horizontally movable state, and a drive system 82b for driving the movable partition member 81b, is used as the pressure variation device 80 according to the modified example of the first embodiment.

The movable partition member 81b divides the interior of the tundish 40 into the pouring nozzle 45 side and the opposite side thereof, and is provided so as to be immersed in the molten copper 200. As the movable partition member 81b, for example, a plate-like member made of a refractory material such as silicon oxide, silicon carbide, silicon nitride or the like can be used.

The movable partition member 81b may divide the molten copper 200 to such a degree that a temporal movement of the molten copper 200 is allowed at the time of the cleaning as described later, and may have a gap between the movable partition member 81b and the inner surface (inner lateral surface and a bottom surface) of the tundish 40. At the time of the normal operation, the molten copper 200 can move from one side to the other side through the gap, interposing the movable partition member 81b.

The movable partition member 81b is horizontally movably provided so that it can be disposed at a closer side to the pouring nozzle 45 at the time of the cleaning, compared to the arrangement at the time of the normal operation. The movable partition plate 81b is attached to, for example, the lid member 42 of the tundish 40. The drive system 82b moves the movable partition member 81b in the horizontal direction. A publicly-known each kind of drive mechanism can be suitably used as the drive system 82b.

At the time of the cleaning, the movable partition member 81b is moved to the pouring nozzle 45 side by the drive system 82b of the pressure variation device 80, that is, by gathering the stored molten copper 200 toward the pouring nozzle 45 side with respect to the movable partition member 81b, the surface of the molten copper at the pouring nozzle 45 side with respect to the movable partition member 81b is raised, and the pressure applied to the pouring nozzle 45 by the molten copper 200 is increased. The cleaning is performed in this manner in the modified example of the first embodiment.

Next, the second embodiment will be described, with reference to FIG. 5A and FIG. 5B. A pressure variation device including a floating member 81c movably provided in the tundish 40 in a vertical direction in a floating state on the surface of the molten copper 200, and a drive system 82c for driving the floating member 81c, is used as the pressure variation device 80 of the second embodiment.

The floating member 81c is provided so as to cover the surface of the molten copper 200 in the tundish 40, and also serves as the lid member 42 of the tundish 40. As the floating member 81c, for example, the plate-like member made of a refractory material such as silicon oxide, silicon carbide, silicon nitride or the like can be used.

The floating member 81c may cover the surface of the molten copper 200 to such a degree that a temporal movement of the molten copper 200 is allowed at the time of the cleaning as described later, and may have gaps between the movable partition member 81c and the inner surface (inner lateral surface) of the tundish 40, or between the movable partition member 81c and the outer surfaces of the lower gutter 25 and the flow rate adjusting pin 41.

The floating member 81c is vertically movably provided so as to be disposed at a lower part at the time of the cleaning, compared to the arrangement at the time of the normal operation. The floating member 81c is moved in the vertical direction by the drive system 82c. A publicly-known each kind of drive mechanism can be suitably used as the drive system 82c.

At the time of the cleaning, the floating member 81c is moved downward by the drive system 82c of the pressure variation device 80 under control of the controller 90, thus increasing the pressure applied to the surface of the molten copper 200 from above, and increasing the pressure applied to the pouring nozzle 45 by the molten copper 200. In the second embodiment, the cleaning is performed in this manner.

Next, the modified example of the second embodiment will be described, with reference to FIG. 6A and FIG. 6B. In the modified example of the second embodiment, an arrangement mode of the floating member 81d of the pressure variation device 80 is different from that of the floating member 81c of the second embodiment, and the floating member 81d is provided so as to cover the surface of the molten copper at the pouring nozzle 45 side in the tundish 40.

A partition member 43 is provided so as to divide the interior of the tundish 40 into the pouring nozzle 45 side and the opposite side thereof in the horizontal direction, and so as to be immersed in the molten copper 200. The floating member 81d is provided at the pouring nozzle 45 side relative to the partition member 43, so as to serve as the lid member 42 at the pouring nozzle 45 side. Further, the lid member 42 at the opposite site of the pouring nozzle 45, is provided on the opposite side of the pouring nozzle 45 relative to the partition member 43. The partition member 43 and the lid member 42 on the opposite side of the pouring nozzle 45, may be provided so as to be fixed to the tundish 40. As the floating member 81d and the partition member 43, for example a plate-like member made of a refractory material such as silicon oxide, silicon carbide, silicon nitride or the like can be used.

The operation at the time of the cleaning in the modified example of the second embodiment, is the same as that of the abovementioned second embodiment. That is, at the time of the cleaning, under control of the controller 90, the floating member 81d is moved downward by the drive system 82d of the pressure variation device 80, thus increasing the pressure applied to the surface of the molten copper 200 from above, and increasing the pressure applied to the pouring nozzle 45 by the molten copper 200.

In the modified example of the second embodiment, the floating member 81d is provided at the pouring nozzle 45 side in a limited manner relative to the partition member 43. Therefore, the floating member 81d is easily driven because the floating member 81d is relatively small, compared to a case in which the floating member 81c is provided over an entire surface of the tundish 40.

Next, the third embodiment will be described, with reference to FIG. 7A and FIG. 7B. A pressure variation device having a gas injector for injecting a gas into a space 44 between the lid member 42 of the tundish 40 and the surface of the molten copper 200, is used as the pressure variation device 80 of the third embodiment.

In the third embodiment, the lid member 42 is provided so as to be fixed to the tundish 40. The lid member 42 may have gaps between the outer surface of the lower gutter 25 and the outer surface of the flow rate adjustment pin 41, but preferably it is provided so as to obtain the airtightness of the space 44 to such an extent as to temporarily pressurize the molten copper 200 at the time of the cleaning described later.

Further, in the third embodiment, a gas inlet port 46 is provided at the bottom of the tundish 40. A gas injector 81e injects a gas 82e into the molten copper 200 in the tundish 40, for example from the gas injection port 46. For example, an inert gas such as nitrogen gas and argon gas, etc., is used as the gas 82e.

The gas 82e injected into the molten copper 200 passes through the molten copper 200 and injected into the space 44. By adjusting an amount of the gas 82e injected into the space 44, the pressure of the space 44 is adjusted. In this manner, the pressure applied to the surface of the molten copper 200 is adjusted by the gas 82e injected into the space 44.

At the time of the cleaning, under control of the controller 90, the gas is injected into the space 44 by the gas injector 81e, thus increasing the pressure applied to the surface of the molten copper 200 from above, and increasing the pressure applied to the pouring nozzle 45 by the molten copper 200. The cleaning is performed in this way in the third embodiment.

In addition, the following effect is also expected. By injecting the gas 82e into the molten copper 200, the inclusion 201 that exists in the molten copper 200 is adsorbed on the bubbles of the gas 82e, and the inclusion 201 floats on the surface of the molten metal.

As described above, the inclusion 201 adhered to the pouring nozzle 45 can be cleaned, by using the apparatus for manufacturing the copper alloy metal material of this embodiment.

By performing such a cleaning, clogging of the pouring nozzle 45 can be suppressed. Further, the pouring nozzle 45 can be kept in a state in which adhesion of the inclusion 201 is small, and therefore the amount of the inclusion 201 mixed into the product is reduced and the quality can be improved.

As described above, the present invention has been described in accordance with the embodiments. However, the present invention is not limited thereto. For example, it is obvious for a skilled person that various modifications, improvements, and combinations, etc., are acceptable.

Preferable aspects of the present invention will be supplementarily described hereafter.

### (Supplementary Description 1)

There is provided an apparatus for manufacturing a copper alloy metal material, including:

a tundish in which molten copper is stored;

a pouring nozzle through which the molten copper passes, the molten copper being flowed out from the tundish;

a pressure variation device that varies a pressure applied to the pouring nozzle by the molten copper; and

a controller that controls the pressure variation device so as to remove inclusions adhered to the pouring nozzle, by increasing the pressure applied to the pouring nozzle by the molten copper.

### (Supplementary Description 2)

There is provided the apparatus for manufacturing a copper alloy metal material of the supplementary description 1, further including

a detector that detects an adhesion of inclusions to the pouring nozzle,

wherein the controller controls the pressure variation device, based on a signal inputted from the detector.

### (Supplementary Description 3)

There is provided the apparatus for manufacturing a copper alloy metal material of the supplementary description 1 or 2, wherein the pressure variation device varies a pressure applied to the pouring nozzle by the molten copper, by varying a height of a surface of the molten copper in an upper part of the pouring nozzle.

### (Supplementary Description 4)

There is provided the apparatus for manufacturing a copper alloy metal material of the supplementary description 3, wherein

the pressure variation device includes a flow rate adjuster that adjusts a flow rate of the molten copper flowed into the tundish, and

the controller controls the flow rate adjuster so as to raise the surface of the molten copper by increasing the flow rate of the molten copper flowing into the tundish.

### (Supplementary Description 5)

There is provided the apparatus for manufacturing a copper alloy metal material of the supplementary description 3, wherein

the pressure variation device divides an interior of the tundish in a horizontal direction, and includes a movable partition member movably provided in the horizontal direction, and a drive system that drives the movable partition member, and

the controller controls the drive system so as to raise the surface of the molten copper at the pouring nozzle side with respect to the movable partition member, by moving the movable partition member to the pouring nozzle side.

### (Supplementary Description 6)

There is provided the apparatus for manufacturing a copper alloy metal material of the supplementary description 1 or 2, wherein the pressure variation device varies the pressure applied to the pouring nozzle by the molten copper, by varying the pressure applied to the surface of the molten copper from above in an upper part of the pouring nozzle.

### (Supplementary Description 7)

There is provided the apparatus for manufacturing a copper alloy metal material of the supplementary description 6, wherein

the pressure variation device includes a floating member provided in the tundish movably in a vertical direction in a floating state on the surface of the molten copper, and

the controller controls the drive system so as to increase the pressure applied to the surface of the molten copper from above by moving the floating member downward.

### (Supplementary Description 8)

There is provided the apparatus for manufacturing a copper alloy metal material of the supplementary description 7, further including:

a partition member provided to horizontally divide an interior of the tundish,

wherein the floating member is provided at the pouring nozzle side with respect to the partition member.

### (Supplementary Description 9)

There is provided the apparatus for manufacturing a copper alloy metal material of the supplementary description 6, including:

a gas injector that injects a gas into a space between a lid member of the tundish and the surface of the molten copper,

wherein the controller controls the gas injector so as to increase the pressure applied to the surface of the molten copper from above, by injecting the gas into the space.

### (Supplementary Description 10)

There is provided the apparatus for manufacturing a copper alloy metal material of the supplementary description 9, wherein the gas injector injects the gas into the molten copper.

### (Supplementary Description 11)

There is provided the apparatus for manufacturing a copper alloy metal material of any one of the first to tenth supplementary descriptions, further including

An alloy component adding part that adds an alloy component to the molten copper, wherein the inclusions contain an oxide of the alloy component.

### (Supplementary Description 12)

There is provided a method for manufacturing a copper alloy material, including:

storing a molten copper in a tundish;

making the molten copper flow out from the tundish through a pouring nozzle;

removing inclusions adhered to the pouring nozzle which is caused during flow out of the molten copper through the pouring nozzle, by increasing a pressure applied to the pouring nozzle by the molten copper.

### (Supplementary Description 13)

There is provided the method for manufacturing a copper alloy material of the supplementary description 12, further including:

detecting an adhesion of the inclusions to the pouring nozzle.

### (Supplementary Description 14)

There is provided the method for manufacturing a copper alloy material of the supplementary description 12 or 13, further including:

adding an alloy component to the molten copper,

wherein the inclusions contain an oxide of the alloy component.

What is claimed is:

1. An apparatus for manufacturing a copper alloy metal material, comprising:
a tundish in which molten copper is stored;
a pouring nozzle through which the molten copper passes, the molten copper being flowed out from the tundish;
a pressure variation device that varies a pressure applied to the pouring nozzle by the molten copper; and
a controller that controls the pressure variation device so as to remove inclusions adhered to the pouring nozzle, by increasing the pressure applied to the pouring nozzle by the molten copper.

2. The apparatus for manufacturing a copper alloy metal material according to claim 1, further comprising:
a detector that detects an adhesion of inclusions to the pouring nozzle,
wherein the controller controls the pressure variation device, based on a signal inputted from the detector.

3. The apparatus for manufacturing a copper alloy metal material according to claim 1, wherein the pressure variation device varies a pressure applied to the pouring nozzle by the molten copper, by varying a height of a surface of the molten copper in an upper part of the pouring nozzle.

4. The apparatus for manufacturing a copper alloy metal material according to claim 1, wherein the pressure variation device varies the pressure applied to the pouring nozzle by the molten copper, by varying the pressure applied to the surface of the molten copper from above in an upper part of the pouring nozzle.

5. A method for manufacturing a copper alloy material, comprising:
storing a molten copper in a tundish;
making the molten copper flow out from the tundish through a pouring nozzle;
removing inclusions adhered to the pouring nozzle which is caused during flow out of the molten copper through the pouring nozzle, by increasing a pressure applied to the pouring nozzle by the molten copper.
